(19) United States
(12) Patent Application Publication
(10) Pub. No.: US 2019/0372194 A1
(43) Pub. Date: Dec. 5, 2019

(54) ANTENNA ASSEMBLY

(71) Applicant: HUBER + SUHNER AG, Herisau (CH)

(72) Inventor: Christian KELLER, Goldach (CH)

(73) Assignee: HUBER + SUHNER AG, Herisau (CH)

(21) Appl. No.: 15/997,314

(22) Filed: Jun. 4, 2018

(51) Int. Cl. H01Q 1/12; H01Q 13/10; H01Q 1/00; H04Q 1/02; H01Q 9/28; H01Q 1/44; H01Q 1/20

(52) U.S. Cl. CPC H01Q 1/1207; H01Q 13/10; H01Q 1/007; H04Q 2201/808; H01Q 9/28; H01Q 1/44; H01Q 1/20; H04Q 1/02

(57) ABSTRACT

The invention concerns an antenna assembly that includes an antenna device and a mount for the antenna device. The antenna device (1) includes a mounting part (11) projecting from the rear end of the antenna device (1). The mount (2) includes a body (21) insertable into an opening of a ceiling or a wall, the body (21) having an internal surface forming a cavity (22) for receiving the mounting part (11) of the antenna device (1). The mount includes at least one resilient member (231, 232) attached to the body (21) enabling receiving and fixing the mounting part (11) of the antenna device (1) in the cavity (22) and simultaneously enabling fixing the mount (2) in the opening of the ceiling or wall.

### BACKGROUND OF THE INVENTION

### Field of the Invention

The present invention relates to an antenna assembly according to the preamble of patent claims. More specifically, the present invention relates to an antenna assembly comprising an antenna device and a mount.

Radio based services, such as WiFi (Wireless local area networking), require installation of antenna devices at various locations, including in ceilings or walls, of buildings, such as in office buildings, restaurants, shopping malls, etc. These buildings may include a dropped ceiling, which is suspended from structural elements above. The antenna device may be installed at the lower surface of the dropped ceiling. The cables for connecting the antenna device with a power source and with signal transceivers of a building may be placed between the dropped ceiling and the structural elements above. In a similar manner, antenna devices may be installed at walls, etc. In such situations, space and visibility for installation of an antenna device are often limited. The market requests low-profile tapered antennas enabling in-building coverage (IBC) applications having high-frequency coverage. The request for 4×4 MIMO systems (Multiple Input Multiple Output) increases. Installation of antenna devices must be simple and reliable.

### DISCUSSION OF RELATED ART

EP3101326B1 discloses a mounting arrangement for mounting a device in an opening. The arrangement comprises an outer sleeve, an inner sleeve arranged inside the outer sleeve, and an adjustment ring arranged inside the outer sleeve. A flange is arranged at a first end of the outer sleeve, arranged to receive said device. The flange is adapted to abut an outer surface of the structure. The inner sleeve is arranged in threaded engagement with the adjustment ring or with the outer sleeve. The adjustment ring comprises a fixing wing extending outwardly through a longitudinally extending aperture in the outer sleeve, the fixing wing having an abutment portion adapted to abut an inner surface of the structure. By relative rotary motion of the inner and outer sleeve, the adjustment ring is movable along a longitudinal direction of the arrangement for adjustment to a thickness of the structure.

US20070217207A1 discloses a recessed lighting fixture which includes a housing having one or more side walls, one or more of which including at least one elongate slot formation, the slot formation including a pair of oppositely extending lateral edge formations, each lateral edge formation having a first dimension, a retaining clip to be located in the slot formation for movement therealong. The retaining clip has a first portion to extend through the slot formation and to travel along an inner surface of the corresponding side wall on opposite sides of the slot formation, a second portion having a second dimension exceeding the first dimension and to travel along an outer surface of a corresponding side wall on opposite sides of the slot formation. The second portion is arranged to be biased outwardly from the housing relative to the first portion, the second portion joined to a third portion, the third portion being arranged to extend through the slot formation in a retained position, in which the third portion is retained against an inner surface of the corresponding lateral edge formation with the second portion in a spring-loaded orientation. The third portion is movable from the retained position to a released position when separated from the lateral edge formation, thereby causing the second portion to be transferred from its spring-loaded orientation to an outwardly extended orientation relative to the housing.

EP2045512A1 discloses a panel component holder arranged to be attached to a panel element. The panel component holder comprises at least one supporting means and a casing including a brim and at least one retainer. The at least one supporting means comprises an attached end being attached to the casing, an elastic means and a free end. Said at least one retainer is arranged to prevent outwardly movement of the at least one supporting means from said casing in a plane coinciding with the centre axis of the casing, wherein the outwardly movement of the supporting means is induced by the elastic means.

U.S. Pat. No. 4,733,339A discloses a clip for retaining a light canister in a ceiling. The clip includes a bendable leg member which is positionable between a first position and a second position. In the first position, the canister is insertable into a hole in a ceiling and in the second position, the bendable leg member is moved away from the canister so as to retain the canister within the ceiling. A brace member extends between the bendable leg member and the canister to retain the bendable leg member in its second position.

### SUMMARY OF THE INVENTION

According to the present invention, an antenna assembly comprises an antenna device and a mount. The antenna device comprises a mounting part projecting from the rear end of the antenna device. The antenna device may comprise an antenna part at the front end of the antenna device. The mount enables mounting the antenna device into an opening of a ceiling or wall. The mount comprises a body which is insertable in the opening of the ceiling or the wall. Thus, the external surface of the body is adapted to the size of the opening of the ceiling or wall. The body has an internal surface forming a cavity for receiving the mounting part of the antenna device. The cavity is adapted to the size of the mounting part of the antenna device. At least one resilient member is attached to the body enabling receiving and fixing the mounting part of the antenna device in the cavity and simultaneously enabling fixing the mount in the opening of the ceiling or wall. Via the mount, the antenna device becomes wedged together with the opening of the ceiling or wall. The antenna device is latched in the mount, and the mount is clamped in the opening of the ceiling or wall. The cavity may extend from a front end of the mount to a rear end of the mount.

In order to install the antenna device in a ceiling or wall, in a first step, the mount is inserted into an opening of the ceiling or wall. The resilient members, or alternatively or additionally resilient tongues described below, may provide for a preliminarily fixing the mount in the opening of the ceiling or wall. The mount can be inserted in the opening using one hand. In a second step, the mounting part of the antenna device can be inserted into the cavity of the body of the mount. The resilient members provide for receiving and fixing the mounting part in the cavity and simultaneously provide for fixing the mount in the opening of the ceiling or wall. The mounting part of the antenna device can be inserted into the cavity using one hand, wherein the mount is already preliminarily fixed in the opening of the ceiling or wall. Between the first step and the second step, cables can be attached to the antenna device using the other hand. For example, after the first step, the cables may extend through the cavity of the mount. The cables may have a sufficient length enabling connection to the antenna device.

In a variation the at least one resilient member includes at least one latch member. The at least one latch member is resiliently arranged in a respective window of the body. The at least one latch member is accessible from the inside of the mount and from the outside of the mount. The at least one latch member has an internal surface enabling receiving and fixing the mounting part of the antenna device in the cavity. For example, the internal surface includes a notch or a recess adapted to cooperate with a ridge arranged at the mounting part of the antenna device or vice-versa. The at least one latch member has an external surface enabling fixing the mount in the opening of the ceiling or wall. The external surface may e.g. include saw teeth or similar elements enabling reliable cooperation with the opening of the ceiling or wall.

Good results can be achieved when the at least one latch member includes an external finger and an internal finger which are interconnected to each other. The external finger is separated from the internal finger. One end of each finger is attached to the other forming in a sectional view a V-shaped structure which is resilient in that both fingers can be deflected with respect to each other. Both fingers are further attached to the body of the mount in a resilient, deflectable manner. The other ends of the fingers are spaced a certain distance apart with respect to each other being part of the resilient arrangement. The fingers may have a predetermined design enabling different elasticity or stiffness adapted to reliably cooperate with the mounting part of the antenna device, a regards the internal finger, and adapted to reliably cooperate with the opening of the ceiling or wall as regards the external finger.

In a variation the at least one resilient member enables removal of the mounting part of the antenna device from the cavity after fixing the mounting part therein, and simultaneously enables that the mount remains at least partly fixed in the opening of the ceiling or wall. Thus, for example in case of a failure of the antenna device, the antenna device can be easily replaced.

Good results can be achieved when the body and/or the cavity have an essentially cylindrical design. Depending on the field of application other designs such as oval, rectangular, etc. may be appropriate. The design of the body is preferably adapted to match the opening of the ceiling or wall and vice versa. In certain cases the antenna can be integrated into the mounting part of the antenna device. Thereby it becomes possible to provide antennas which allow flush mount design with respect to the surface in which they are integrated. In these cases the mount, respectively the cavity are designed accordingly.

Normally an end of the body facing away from the ceiling or wall includes a stop, e.g. in the form of a rim protruding in an outward direction (radially) above an outer surface of the mount. The stop limits insertion of the mount into the opening of the ceiling or wall. The stop may include additional elements for fixing the mount to the ceiling or wall, such as screw holes, etc. Depending on the field of application other designs are possible.

If appropriate, the internal surface forming the cavity of the body may include one or more guiding structures for guiding the mounting part of the antenna device. The guiding structures may be adapted for smooth insertion of the mounting part into the cavity. For example, the guiding structures may be designed to reduce friction and/or compensate imprecisions between the mounting part and the cavity.

Alternatively or in addition, the at least one resilient member may include a plurality of resilient members attached to the body at regularly spaced positions along a circumference of the body. For example, the resilient members are arranged with respect to the body at angles of 180°, 120°, 90°, 60°, etc. Good results can be achieved when the resilient members are arranged on regularly spaced positions, as reliability of fixing the mounting part of the antenna device in the cavity as well as fixing the mount in the ceiling or wall can be improved.

In a variation, the at least one resilient member includes an internal surface with a ramp and a recess enabling receiving and fixing a ridge of the mounting part of the antenna device. Inverse arrangement is possible. While inserting the mounting part into the cavity, in a first stage the ramp serves for horizontally bending the at least one resilient member outwards, and in a second stage the recess serves for fixing the mounting part of the antenna device in the cavity by cooperation of the recess with the ridge.

In a variation, the at least one resilient member includes an external surface with saw teeth enabling fixing the body in the opening of the ceiling or wall. The saw teeth provide for higher friction. Other designs are possible. The external surface may exhibit a bended surface, wherein in a first stage of the insertion of the mount into an opening of a ceiling or wall, clamping of the mount in the opening is less strong than in a second later stage of insertion.

In a variation, at least one resilient tongue is attached to the body enabling or additionally supporting preliminarily fixing the mount in the opening of the ceiling or wall. The design of the resilient members is therefore not necessarily required to provide a preliminary fixing of the mount in the opening of the ceiling or wall, which enables focusing the design of the resilient members to reliable fixing of the mount.

In a variation, the at least one resilient tongue comprises a plurality of resilient tongues attached to the body at positions enabling or supporting preliminarily fixing the mount in ceilings or walls of different thickness. For example, in direction from a front end of the mount to the rear end of the mount, a plurality of resilient tongues is attached to the body at irregular or regular spaced positions, in accordance to different thicknesses of ceilings or walls.

If appropriate, the at least one resilient tongue is attached to at least one bendable structure enabling removal of the mount from the opening of the ceiling or wall after fixing the mount therein. The bendable structure may enable bending the resilient tongues inwards and away from the opening in the ceiling or wall, thereby loosing cooperation between the resilient tongues and the opening and enabling removal of the mount.

The at least one bendable structure may include a predetermined breaking point. For example, the bendable structure may be bended inwards until at a predetermined position an attachment of the bendable structure to the body of the mount is broken at the breaking point, thereby loosing cooperation between the resilient tongues and the opening of the ceiling or wall.

Furthermore, if appropriate the at least one bendable structure may include a grip portion for manually gripping and bending the at least one bendable structure. The grip portion may include a ribbed surface.

In a variation, the at least one resilient tongue includes a plurality of resilient tongues attached to the body at regularly spaced positions along a circumference of the body. For example, the resilient tongues are attached to the body at angles of 180°, 120°, 90°, 60°, etc. Because of the regularly spaced positions, reliability of preliminarily fixing the mount in the ceiling or wall is improved.

The invention also concerns a mount of an antenna assembly as described above.

It is to be understood that both the foregoing general description and the following detailed description present embodiments, and are intended to provide an overview or framework for understanding the nature and character of the disclosure. The accompanying drawings are included to pro-vide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims. The drawings are showing:

FIG. 1 illustrates schematically an antenna assembly comprising an antenna device and a mount;

FIG. 2 illustrates schematically the antenna assembly illustrated in FIG. 1, wherein a mounting part of the antenna device is received in a cavity of the body of the mount;

FIG. 3 illustrates schematically the antenna assembly illustrated in FIGS. 1-2, wherein the mount is fixed in an opening of a ceiling or wall;

FIG. 4 illustrates schematically a lateral view of a mount;

FIG. 5 illustrates schematically a lateral cut of the mount illustrated in FIG. 4; and

FIG. 6 illustrates schematically a detailed view of a resilient member of the mount illustrated in FIG. 5.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be understood as limited to the embodiments set forth herein; rather, these embodiments are provided so that this disclosure will satisfy applicable legal requirements. Whenever possible, like reference numbers will be used to refer to like components or parts.

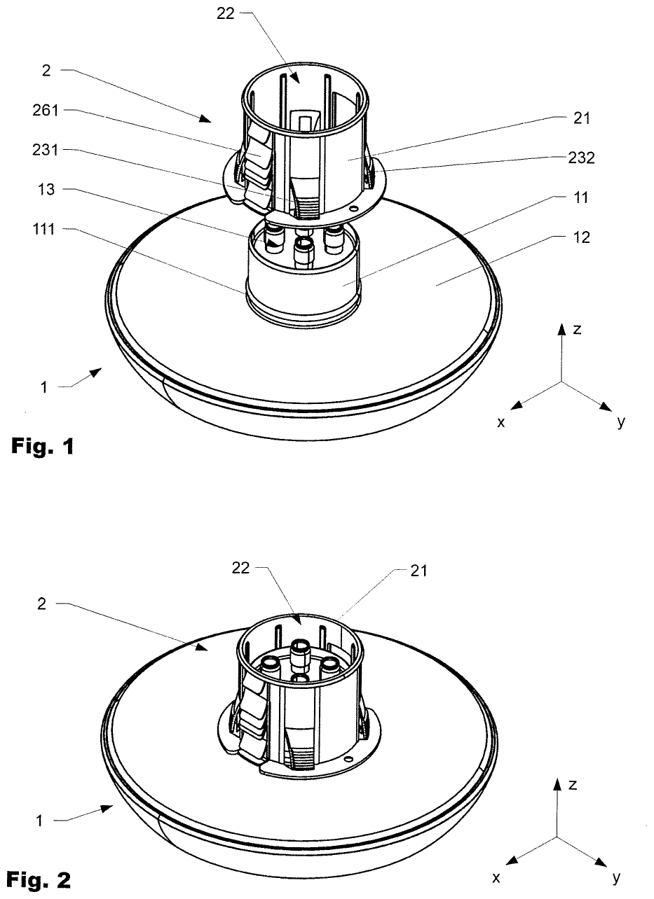

FIG. 1 illustrates schematically an antenna assembly comprising an antenna device 1 and a mount 2.

In an embodiment, the antenna device 1 is an indoor or outdoor antenna device for installation in an office area, restaurant, shopping mall, etc. for providing radio based services on the basis of radio technologies such as MIMO (Multiple Input Multiple Output), LB LTE (Long Term Evolution), WiFi (Wireless loca are networking), etc., in frequency bands of for example 1.7-6 GHz, at VSWR (Voltage Standing Wave Ratio) of up to for example 1.5, with an isolation of for example 20 dB. The antenna device may have a Low PIM (passive intermodulation).

The antenna device 1 is designed for installation on a ceiling or wall. The antenna device 1 includes a mounting part 11 projecting from the rear end of the antenna device 1. The antenna device 1 includes an antenna part 12 at the front end of the antenna device 1. The antenna part 12 is designed to provide radio based services when mounted on a ceiling or wall. The antenna device 1, namely the mounting part 11 and the antenna part 12, may include any suitable material, such as plastic, metal, etc. The antenna part 12 includes electronic devices such as radio transmitters, radio receivers, amplifiers, etc. The mounting part 11 has a rigid design enabling reliably mounting the antenna device 1 to a ceiling or wall as explained below, and further providing a housing for cables for connecting the electronic devices of the antenna part 12 with power sources and/or signal transceivers of a building.

The mounting part 11 of the antenna device 1 illustrated in FIG. 1 has an essentially cylindrical design. The antenna part 12 of the antenna device 1 has a radome shape. In other embodiments, one or more parts of the antenna device 1 may have an oval design, or a cuboid design, or any other design.

As illustrated in FIG. 1, the mounting part 11 includes one or more cables 13 for connecting the antenna device 1 to a power source and/or to signal transceivers. The one or more cables 13 may include electrical cables, optical cables, coaxial cables, etc.

As illustrated in FIG. 1, the mounting part 11 of the antenna device 1 includes a ridge 111, which will be explained in more detail below.

As illustrated in FIG. 1, the antenna assembly includes a mount 2. The mount 2 has a design adapted to the mounting part 11 of the antenna device 1, such as a cylindrical design. The mount 2 includes a body 21 which is insertable into an opening of a ceiling or wall. The mount 2 has a design adapted to the opening of the ceiling or wall, such as a cylindrical design. The body 21 has an internal surface forming a cavity 22 for receiving the mounting part 11 of the antenna device 1. The mount 2 includes at least one resilient member 231, 232 attached to the body 21. The at least one resilient member 231, 232 enables receiving and fixing the mounting part 11 of the antenna device 1 in the cavity 22 and simultaneously enabling fixing the mount in the opening of the ceiling or wall.

As illustrated in FIG. 1, the body 21 and the cavity 22 have an essentially cylindrical design.

In an embodiment, the at least one resilient member 231, 232 includes at least one latch member. A latch member may be resiliently arranged in a respective window of the body 21. As illustrated in FIG. 1, the window may have a rectangular design, wherein the latch member is attached to the upper part of the window, and wherein, depending on forces applied to the latch member, the latch member may bend from an initial position in an out of the window in a horizontal direction. The latch member may include an internal surface enabling receiving and fixing the mounting part 11 of the antenna device 1. The internal surface may cooperate with the ridge 111 of the mounting part 11 of the antenna device 1. The latch member may include an external surface enabling fixing the mount in the opening of the ceiling or wall. The external surface may include a saw teeth.

Thus, in order to install the antenna device 1 in a ceiling or wall, after a respective opening has been provided in the ceiling or wall, in a first step the mount 2 is introduced in the opening of the ceiling or wall. The at least one resilient member 231, 232, such as the latch member described above, may bend inwards, thereby preliminarily fixing the mount 2 in the opening of the ceiling or wall. In a second step, the mounting part 11 of the antenna device 1 is introduced into the cavity 22 of the body 21 of the mount 2. The at least one member 231, 232, such as the latch member described above may cooperate with the mounting part 11 of the antenna device 1, such as with the ridge 111 of the mounting part 11, in order to receive and fix the mounting part 11 in the cavity 22. The at least one resilient member 231, 232, such as the latch member described above, may be designed to transmit a horizontal force from the mounting part 11 of the antenna device 1 to the opening in the ceiling or wall, and to transmit a horizontal force from the opening in the ceiling or wall to the mounting part 11 of the antenna device 1. Thus, via the mount 2, the mounting part 11 of the antenna device 1 becomes wedged together with the opening of the ceiling or wall. Accordingly, the antenna device 1 can be installed in a simple and reliable manner. In particular, a one-hand installation is enabled, which is particularly useful for connecting cables to the antenna device 1 between the first step and the second step. Moreover, the installation does not require screws, threads, fittings, etc. No tools are needed for installation. A simple, cost effective one part solution is provided. The mount 2 may be of plastic. Apart from the opening in the ceiling or wall, no holes need to be drilled. A one-sided installation is enabled. Removing the antenna device 1 from the mount 2 is possible without removing the mount 2 from the ceiling or wall or even without destroying the mount 2.

The resilient members 231, 232 may be attached to the body 21 of the mount 2 at regularly spaced positions along a circumference of the body 21. For example, pairs of diametrically opposed resilient members 231, 232 may be attached to the body 21. For example, resilient members 231, 232 may be attached to the body 21 at angles of 180°, 120°, 90°, 60°, etc. FIG. 1 illustrates an embodiment with resilient members 231, 232, 233, 234 attached at angles of 90° along a circumference of the body 21.

FIG. 2 illustrates schematically the antenna assembly illustrated in FIG. 1, wherein the mounting part 11 of the antenna device 1 is received in the cavity 22 of the body 21 of the mount 2. As will be described further below, the ridge 111 of the mounting part 11 cooperates with the resilient members 231, 232 of the mount 2.

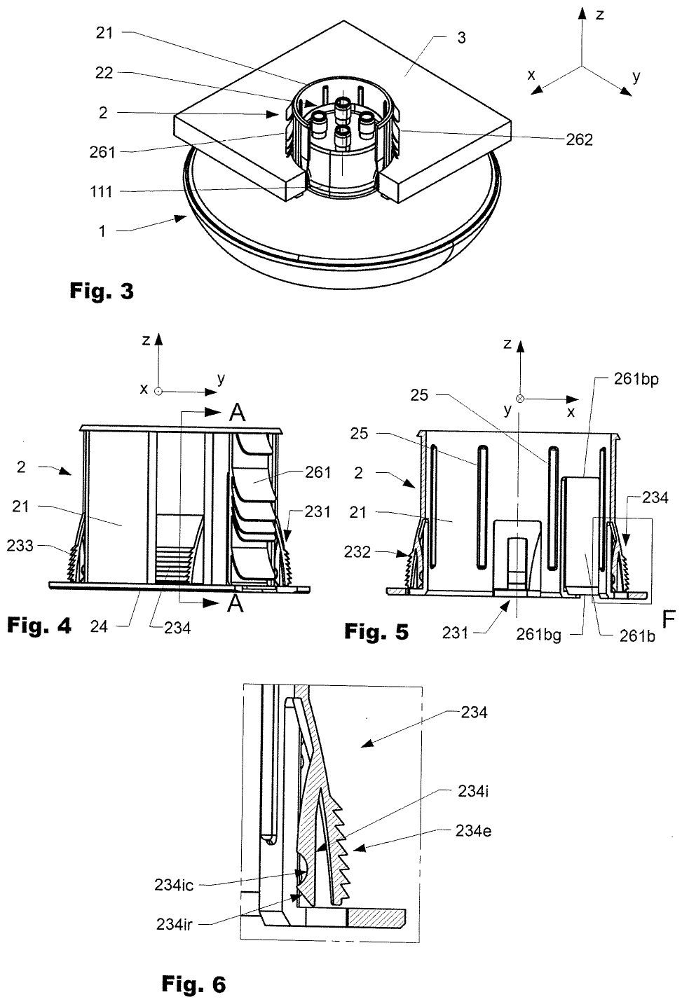

FIG. 3 illustrates schematically the antenna assembly illustrated in FIGS. 1-2, wherein the mount 2 is fixed in an opening of a ceiling or wall 3, and wherein the mounting part 11 of the antenna device 1 is received and fixed in the cavity 22 of the body 21 of the mount 2. FIG. 3 illustrates only a segment of a ceiling or wall, which in reality has much larger horizontal (or vertical) dimensions than the antenna device 1.

FIG. 4 illustrates schematically a lateral view of a mount 2. The mount 2 includes a body 21. At least one resilient member 231, 232, 233, 234 is attached to the body 21. The at least one resilient member includes at least one latch member.

As illustrated in FIG. 4, an end of the body 21 facing away from the ceiling or wall includes a stop 24, which limits insertion of the mount 2 in an opening of a ceiling or wall.

FIG. 5 illustrates schematically the lateral cut A-A of the mount 2 illustrated in FIG. 4. The mount 2 includes a body 21. At least one resilient member 231, 232, 233, 234 is attached to the body 21, enabling simultaneous fixing of a mounting part 11 of an antenna device 1 in a cavity 22 of the body 21 and fixing of the mount 2 in an opening of a ceiling or wall.

As illustrated in FIG. 5, the body 21 includes one or more guiding structures 25 for guiding the mounting part 11 of the antenna device. The guiding structures 25 may be attached to the internal surface of the body 21 at regularly spaced positions. The guiding structures 25 may be designed for centering the mounting part 11 of the antenna device 1 in the mount 2.

FIG. 6 illustrates schematically the detailed view F of the resilient member 234 of the mount 2 illustrated in FIG. 5. The resilient members 231, 232, 233 may be constructed correspondingly.

The resilient member 234 includes an external finger 234e and an internal finger 234i. One end of the fingers 234i, 234e is attached to each other, and further attached to the body 21. The other end of the fingers 234i, 234e is spaced apart from each other.

The fingers 234i, 234e can have different designs, in particular as regards geometry, material, elasticity, etc.

As illustrated in FIG. 6, the internal finger 234i includes an internal surface with a ramp 234ir and a recess 234ic enabling receiving and fixing a ridge 111 of a mounting part 11 of an antenna device 1. Thus, when the mounting part 11 of the antenna device 1 is inserted into the cavity 22 of the body 21 of the mount 2, at a predetermined position of insertion, the ridge 111 starts to cooperate with the ramp 234ir of the internal finger 234i, thereby bending the internal finger 234i in a horizontal direction outwards. After further insertion of the mounting part 11 into the cavity 22, the ridge 111 cooperates with the recess 234ic, wherein because of the elasticity of the internal finger 234i and the design of the recess 234ic, the ridge 111 is held within the recess 234ic, thereby fixing the mounting part 11 in the cavity 22. The internal surface of the internal finger 234i may have other designs.

As illustrated in FIG. 6, the external finger 234e includes an external surface with saw teeth 234es, which are designed to cooperate with the opening of the ceiling or wall in order to fix the mount in the opening of the ceiling or wall. The external surface of the external finger 234e may have other designs. Thus, the internal finger 234i and the external finger 234e enable simultaneously fixing the mounting part 11 of the antenna device 1 in the cavity 22 of the body 21 of the mount 2 and fixing the mount 2 in the opening of the ceiling or wall 3.

As illustrated in FIGS. 1-5, the mount 2 may include at least one resilient tongue 261, 262. The at least one resilient tongue may be attached to the body 21 at positions enabling or supporting preliminarily fixing the mount in ceilings or walls of different thickness. In order to provide the functionality of enabling or supporting preliminarily fixing the mount in ceiling or walls, the at least one resilient tongue 261, 262 may have a respective design, in particular as regards geometry, material, elasticity, etc. When the mount is inserted into an opening of a ceiling or wall, the at least one resilient tongue 261, 262 cooperates with the opening (respectively the walls of the opening), thereby enabling or supporting preliminarily fixing the mount 2.

As illustrated in FIGS. 4-5, the at least one resilient tongue 261, 262 may be attached to at least one bendable structure 261b, 262b enabling removal of the mount 2 from the opening of the ceiling or wall after fixing the mount 2 therein. For example, the bendable structure 261b, 262b may enable a horizontal bending inwards and away from the opening, thereby loosing cooperation of the at least one resilient tongue 261, 262 with the opening of the ceiling or wall, thereby enabling removing the mount 2.

As illustrated in FIG. 5, the at least one bendable structure 261b, 262b may include a predetermined breaking point. For example, in order to remove the mount 2 from a ceiling or wall, the bendable structure 261b, 262b may be removed from the mount 2, thereby loosing cooperation with the opening of the ceiling or wall.

As illustrated in FIG. 5, the at least one bendable structure 261b, 262b may include a grip portion 261bg, 262bg for manually gripping and bending the at least one bendable structure 261b, 262b. The grip portion 261bg, 262bg may include a ripped surface.

As illustrated in FIGS. 1-5, the at least one resilient tongue 261, 262 may include a plurality of resilient tongues attached to the body 21 at regularly spaced positions along a circumference of the body 21. For example, pairs of diametrically opposed resilient tongues 261, 262 may be attached to the body 21. For example, resilient tongues 261, 262 may be attached to the body 21 at angles of 180°, 120°, 90°, 60°, etc. FIGS. 1-5 illustrate an embodiment with diametrically opposed pairs of resilient tongues.

The mount 2 may cooperate with ceilings or walls comprising panels constructed of wood, cement, plastic, metal, etc. In case of metal panels, resilient tongues 261, 262 may not be used.

It is claimed:

1. An antenna assembly comprising:
an antenna device (1) including a mounting part (11) projecting from a rear end of the antenna device (1); and
a mount (2) for the antenna device (1), the mount (2) comprising:
a body (21) insertable into an opening of a ceiling or a wall, the body (21) having an internal surface forming a cavity (22) for receiving the mounting part (11) of the antenna device (1); and
at least one resilient member (231, 232) attached to the body (21) enabling receiving and fixing the mounting part (11) of the antenna device (1) in the cavity (22) and simultaneously enabling fixing the mount (2) in the opening of the ceiling or wall.

2. The antenna assembly of claim 1, wherein the at least one resilient member (231, 232) includes at least one latch member, the at least one latch member resiliently arranged in a respective window of the body (21), the at least one latch member having an internal surface enabling receiving and fixing the mounting part (11) of the antenna device (1) in the cavity (22), and the at least one latch member having an external surface enabling fixing the mount (2) in the opening of the ceiling or wall.

3. The antenna assembly of claim 1, wherein the at least one latch member includes an external finger (231e) and an internal finger (231i), wherein one end of each finger (231e, 231i) is attached to each other, and wherein an other end of each finger (231e, 231i) is spaced apart from each other.

4. The antenna assembly of claim 1, wherein the at least one resilient member (231, 232) enables removal of the mounting part (11) of the antenna device (1) from the cavity (22) after fixing the mounting part (11) therein, and simultaneously enables that the mount (2) remains at least partly fixed in the opening of the ceiling or wall.

5. The antenna assembly of claim 1, wherein the body (21) and/or the cavity (22) have a generally cylindrical design.

6. The antenna assembly of claim 1, wherein an end of the body (21) facing away from the ceiling or wall includes a stop (24).

7. The antenna assembly of claim 1, wherein the internal surface forming the cavity (22) of the body (21) includes one or more guiding structures (25) for guiding the mounting part (11) of the antenna device (1).

8. The antenna assembly of claim 1, wherein the at least one resilient member (231, 232) includes a plurality of resilient members (231, 233; 232, 234) attached to the body (21) at regularly spaced positions along a circumference of the body (21).

9. The antenna assembly of claim 1, wherein the at least one resilient member (231, 232) includes an internal surface with a ramp (231ir) and a recess (231ic) enabling receiving and fixing a ridge (111) of the mounting part (11) of the antenna device (1).

10. The antenna assembly of claim 1, wherein the at least one resilient member (231, 232) includes an external surface with saw teeth (231es) enabling fixing the body (21) in the opening of the ceiling or wall (3).

11. The antenna assembly of claim 1, further comprising at least one resilient tongue (261, 262) attached to the body (21) enabling or additionally supporting preliminarily fixing the mount (2) in the opening of the ceiling or wall.

12. The antenna assembly of claim 11, wherein the at least one resilient tongue (261, 262) comprises a plurality of resilient tongues attached to the body (21) at positions enabling or supporting preliminarily fixing the mount (2) in ceilings or walls of different thickness.

13. The antenna assembly of claim 11, wherein the at least one resilient tongue (261, 262) is attached to at least one bendable structure (261b, 262b) enabling removal of the mount (2) from the opening of the ceiling or wall after fixing the mount (2) therein.

14. The antenna assembly of claim 11, wherein the at least one bendable structure (261b, 262b) includes a predetermined breaking point (261bp, 262bp).

15. The antenna assembly of claim 13, wherein the at least one bendable structure (261b, 262b) includes a grip portion (261bg, 262bg) for manually gripping and bending the at least one bendable structure (261b, 262b).

16. The antenna assembly of claim 11, wherein the at least one resilient tongue (261, 262) includes a plurality of resilient tongues attached to the body (21) at regularly spaced positions along a circumference of the body (21).

17. A mount of an antenna assembly according to claim 1.
